(19) United States
(12) Patent Application Publication
(10) Pub. No.: US 2016/0253216 A1
(43) Pub. Date: Sep. 1, 2016

(54) ORDERING SCHEMES FOR NETWORK AND STORAGE I/O REQUESTS FOR MINIMIZING WORKLOAD IDLE TIME AND INTER-WORKLOAD INTERFERENCE

(71) Applicant: Strato Scale Ltd., Herzlia (IL)

(72) Inventor: Yaron Greenberger, Tel Aviv (IL)

(21) Appl. No.: 15/050,481

(22) Filed: Feb. 23, 2016

Related U.S. Application Data
(60) Provisional application No. 62/120,935, filed on Feb. 26, 2015.

(51) Int. Cl. G06F 9/50

(52) U.S. Cl. CPC G06F 9/5083

(57) ABSTRACT

A method includes receiving, from one or more workloads that are processed by one or more processors, requests to access data over a communication network or on a storage device. An order is defined among the requests, in accordance with a criterion that aims to minimize an overall idle time of the one or more processors in processing the multiple workloads. The requests are served in accordance with the defined order.

### CROSS-REFERENCE TO RELATED APPLICATIONS

This application claims the benefit of U.S. Provisional Patent Application 62/120,935, filed Feb. 26, 2015, whose disclosure is incorporated herein by reference.

### FIELD OF THE INVENTION

The present invention relates generally to data network communication and data storage in computer systems, and particularly to methods and systems for serving network and storage Input/Output (I/O) requests.

### SUMMARY OF THE INVENTION

An embodiment of the present invention that is described herein provides a method including receiving, from one or more workloads that are processed by one or more processors, requests to access data over a communication network or on a storage device. An order is defined among the requests, in accordance with a criterion that aims to minimize an overall idle time of the one or more processors in processing the multiple workloads. The requests are served in accordance with the defined order.

In some embodiments, defining the order includes distinguishing between blocking requests and non-blocking requests, and giving precedence to one or more of the blocking requests over one or more of the non-blocking requests. In a disclosed embodiment, defining the order includes giving precedence to a request that is issued by a first workload and blocks processing of a second workload.

In an embodiment, defining the order includes receiving a hint from an operating system or from a virtualization layer, and setting the order based on the hint. In an example embodiment, the workloads, and the operating system or virtualization layer, run in a given compute node, and setting the order includes providing the hint to a remote element external to the given compute node. Additionally or alternatively, defining the order may include receiving, from an operating system or from a virtualization layer, a notification that a given workload is idle, and setting the order based on the notification.

In an example embodiment, defining the order includes giving precedence to a first I/O request that pages-in a memory page into a local memory from the communication network or from the storage device, relative to a second I/O request that does not page-in any memory page. In another embodiment, defining the order includes giving precedence to a first I/O request that accesses first data having a first access frequency, relative to a second I/O request that accesses second data having a second access frequency, lower than the first access frequency.

In yet another embodiment, defining the order includes giving precedence to a first I/O request identified as synchronous, relative to a second I/O request identified as asynchronous. In still another embodiment, defining the order includes giving precedence to a first write request identified as a barrier write, relative to a second write request identified as a non-barrier write.

In a further embodiment, defining the order includes giving precedence to a read request relative to a write request. In another embodiment, defining the order includes giving precedence to a first I/O request that transfers first data having a first data size, relative to a second I/O request that transfers second data having a second data size, larger than the first data size. In yet another embodiment, defining the order includes giving precedence to a first I/O request issued by a first type of workload, relative to a second I/O request issued by a second type of workload.

There is additionally provided, in accordance with an embodiment of the present invention, an apparatus including an interface and a processor. The interface is configured for connecting to a communication network or a storage device. The processor is configured to receive, from one or more workloads that are processed by one or more processors, requests to access data over the communication network or on the storage device, to define an order among the requests in accordance with a criterion that aims to minimize an overall idle time of the one or more processors in processing the multiple workloads, and to serve the requests in accordance with the defined order.

There is also provided, in accordance with an embodiment of the present invention, a computer software product, the product including a tangible non-transitory computer-readable medium in which program instructions are stored, which instructions, when read by a processor, cause the processor to receive, from one or more workloads that are processed by one or more processors, requests to access data over a communication network or on a storage device, to define an order among the requests in accordance with a criterion that aims to minimize an overall idle time of the one or more processors in processing the multiple workloads, and to serve the requests in accordance with the defined order.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a computing system, in accordance with an embodiment of the present invention; and

FIG. 2 is a flow chart that schematically illustrates a method for serving I/O requests, in accordance with an embodiment of the present invention.

### DETAILED DESCRIPTION OF EMBODIMENTS

### Overview

Embodiments of the present invention that are described herein provide improved methods and systems for serving I/O requests issued by workloads in a computing system. In an example embodiment, the computing system comprises a computer, and the workloads comprise Virtual Machines (VMs) that issue I/O requests. Alternatively, the computing system may comprise a cluster of multiple compute nodes.

In the disclosed embodiments, the computing system comprises one or more processors that run one or more workloads. As part of the system operation, the workloads issue I/O requests, e.g., read requests and write requests, for accessing data over a computer network or on a storage device. The system further comprises a scheduler that orders and schedules the I/O requests. Unlike other known or possible scheduling schemes, the disclosed scheduler orders and serves the I/O requests in accordance with a criterion that aims to minimize the overall idle time of the processors in processing the workloads. I/O requests being ordered may belong to the same workload or to different workloads.

In an example embodiment, the scheduler distinguishes between blocking and non-blocking I/O requests, and orders the I/O requests in an order that gives precedence to blocking I/O requests over non-blocking I/O requests. When using this scheduling scheme, blocking I/O requests, which cause workloads to halt and wait for response, are served first. As a result, idle time of the processors is reduced.

In many practical cases, the same type of I/O request may be blocking or non-blocking, depending on the internal design or organization of the workload. Therefore, distinguishing between blocking and non-blocking I/O requests often involves some insight into the workloads that produce the I/O requests and consume their results. Several example techniques for distinguishing between blocking and non-blocking I/O requests are described herein.

In some embodiments, ordering of the I/O requests is carried out by one or more remote elements that are external to the local compute node on which the workloads run. For example, when sending I/O requests over a network, the scheduler in the local compute node may send hints that distinguish between blocking and non-blocking I/O requests to remote elements that will process the I/O requests. Such remote elements may comprise, for example, network switches en-route to the destinations of the I/O requests, remote NICs, remote compute nodes, and/or remote storage devices. The remote elements may then serve the I/O requests in accordance with the desired order based on the hints.

It is also important to note that the disclosed techniques typically affect only the order in which I/O requests are served, and do not modify the bandwidths or other Service-Level Objectives (SLOs) assigned to the different workloads. For example, the disclosed techniques typically ensure that workloads that are assigned the same Quality-of-Service (QoS) level still receive similar bandwidths.

The disclosed techniques typically do not aim to increase the efficiency of accessing the network or storage device, but rather to improve the computational efficiency of the processors that run the workloads. Nevertheless, the disclosed techniques can be combined with scheduling schemes that aim to utilize the network or storage resources more efficiently, so as to further improve the performance of the computing system.

### System Description

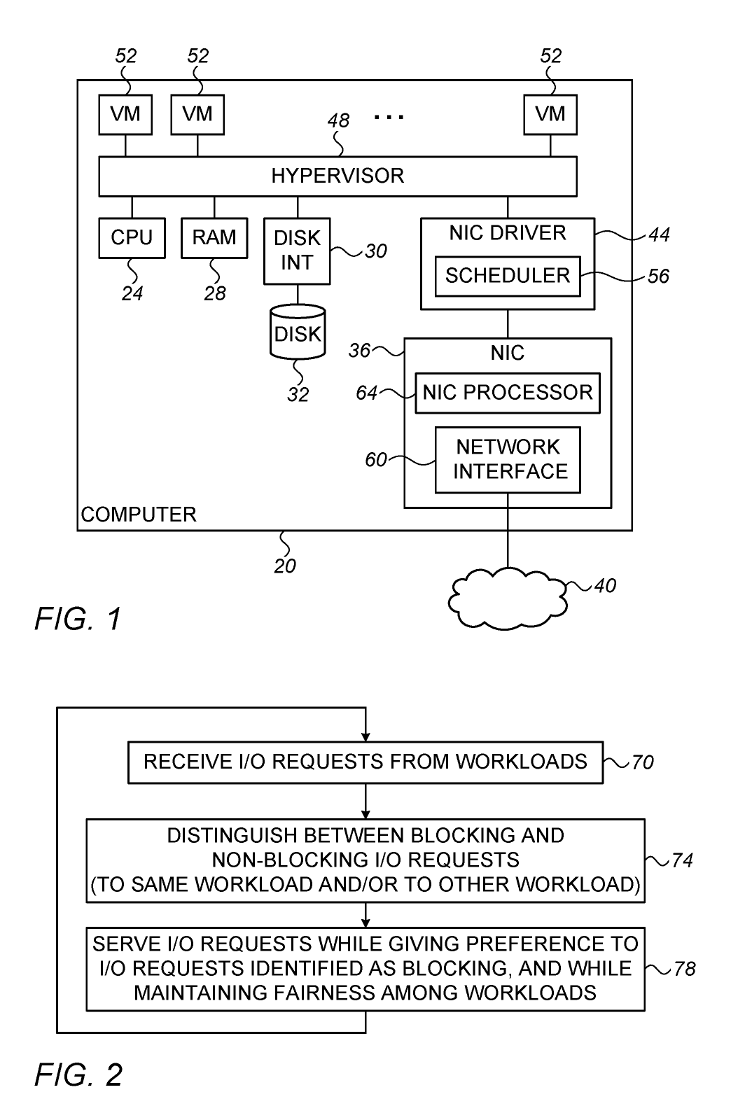

FIG. 1 is a block diagram that schematically illustrates a computing system, in accordance with an embodiment of the present invention. In the present example, the computing system comprises a computer 20 such as a personal computer, a server in a data center or other computer cluster, or any other suitable computer.

In the embodiment of FIG. 1, computer 20 comprises a Central Processing Unit (CPU) 24, a volatile memory 28, a disk interface 30, one or more storage devices 32, and a Network Interface Controller (NIC) 36. CPU 24 typically comprises one or more processors, e.g., processing cores. Volatile memory 28 is also referred to as Random Access Memory (RAM) or simply as a memory, and may comprise, for example, one or more Dynamic RAM (DRAM) or Static RAM (SRAM) devices. Storage devices 32 may comprise, for example, one or more Solid State Drives (SSDs) and/or Hard Disk Drives (HDDs). Disk interface 30 may comprise, for example, a suitable HDD or SSD controller.

NIC 36 connects computer 20 to a computer network 40, e.g., a Local-Area Network (LAN), a Wide-Area Network (WAN) such as the Internet, or any other suitable network. In the present example, NIC 36 comprises a network interface 60 for connecting to network 40, and a NIC processor 64 that carries out the various processing functions of the NIC. A NIC driver 44 controls NIC 36. NIC driver 44 is typically implemented as a software module running on CPU 24.

CPU 24 runs a virtualization layer, which allocates physical resources of computer 20 to one or more workloads. In the present example, the virtualization layer comprises a hypervisor 48, and the workloads comprise Virtual Machines (VMs) 52. Physical resources provided to the workloads may comprise, for example, CPU resources, volatile memory (e.g., RAM) resources, storage resources (e.g., resources of disks 32) and networking resources, e.g., resources of NIC 36 in accessing network 40.

Additionally or alternatively to VMs 52, other types of workloads may comprise, for example, Operating-System containers, processes, applications, or any other suitable workload type. The description that follows refers mainly to VMs for the sake of clarity. The disclosed techniques, however, are applicable in a similar manner to any other type of workload.

As part of their operation, VMs 52 issue I/O requests for accessing data over network 40 or on disk 32. The I/O requests may, for example, write data over network 40 to some location external to computer 20, read data over network 40 from a location external to computer 20, write data to disk 32 or read data from disk 32.

The I/O requests for accessing data over network 40 are processed by driver 44 and forwarded to NIC 36. The I/O requests for accessing data on disk 32 are processed by interface 30 and forwarded to disk 32.

For the sake of clarity, the description that follows refers mainly to scheduling of I/O requests for accessing data over network 40. In some embodiments, driver 44 comprises a scheduler 56, which prioritizes and schedules these I/O requests using methods that are described in detail below. The disclosed techniques, however, can be used in a similar manner for scheduling I/O requests for accessing data on disk 32. For this purpose, a storage scheduler (not shown) may run in interface 30, or in hypervisor 48, for example. Any of the features described below with regard to scheduler 56 can be carried out in a similar manner by the storage scheduler.

In some cases, the I/O requests issued to NIC 36 or disk 32 may be generated by hypervisor 48 in response to commands or requests by VMs 52. In the context of the present patent application and in the claims, such I/O requests are also regarded as originating in the VMs. Generally speaking, I/O requests are regarded herein as being issued by the workloads even though they may pass through some intermediary entity before reaching driver 44, NIC 36, interface 30 and/or disk 32. This intermediary entity may modify, reformat, aggregate or encapsulate the I/O requests, or even convert the I/O requests to a different protocol.

The computing system configuration shown in FIG. 1 is an example configuration that is chosen purely for the sake of conceptual clarity. In alternative embodiments, any other suitable system configuration can be used. For example, in some embodiments the functionality of scheduler 56 may be embodied in NIC processor 64 of NIC 36. Such an implementation offloads the scheduling task from CPU 24 to NIC 36.

The disclosed techniques are typically implemented in software, but may also be implemented in hardware or using a combination of software and hardware elements. In particular, the elements of NIC 36 and NIC driver 44, including scheduler 56, and/or the storage scheduler, may be implemented in software, in hardware, or using both.

Typically, CPU 24 comprises one or more general-purpose processors, which are programmed in software to carry out the functions described herein. The software or components thereof (e.g., hypervisor 48, VMs 52 or other workloads, NIC driver 44, scheduler 56, the storage scheduler and/or other software components) may be downloaded to the processors in electronic form, over a network, for example, or it may, alternatively or additionally, be provided and/or stored on non-transitory tangible media, such as magnetic, optical, or electronic memory.

### Prioritization of I/O Requests for Minimizing Overall CPU Idle Time

As noted above, the embodiments described below refer to scheduling network I/O requests, for the sake of clarity. All of these techniques can be carried out in a similar manner for scheduling storage I/O requests.

In some embodiments, scheduler 56 receives the various I/O requests from VMs 52, and orders the I/O requests in accordance with a criterion that aims to minimize the overall idle time of CPU 24 in processing the multiple workloads. Typically, scheduler 56 distinguishes between blocking and non-blocking I/O requests, and aims to serve the blocking I/O requests first.

FIG. 2 is a flow chart that schematically illustrates a method for serving I/O requests, in accordance with an embodiment of the present invention. The method begins with scheduler 56 receiving I/O requests issued by VMs 52, at a request input step 70. Scheduler 56 classifies the received I/O requests into blocking I/O requests and non-blocking I/O requests, at a classification step 74.

In the context of the present patent application and in the claims, the term “blocking I/O request” refers to an I/O request that causes one or more workloads to halt until served, e.g., until receiving a response or acknowledgement. The halted workloads may comprise the same workload that issued the blocking I/O request, and/or a different workload. The term “non-blocking I/O request” refers to an I/O request that does not halt any workload, i.e., permits all workloads to continue processing even if unserved, at least for a certain period of time. Note that the same type of I/O request may be blocking or non-blocking, depending on the internal organization of the workloads.

At an ordering step 78, scheduler 56 sets the order in which the I/O requests are served, e.g., the order in which the I/O requests are forwarded to NIC 36. The order depends on the classification results of step 74, and gives precedence to blocking I/O requests over non-blocking requests. Scheduler 56 serves the I/O requests in accordance with this order.

When setting the order in which the I/O requests are served, scheduler 56 typically takes into consideration the need to maintain a certain degree of fairness among workloads. Unless fairness is maintained, it is possible, for example, that non-blocking requests will be deferred indefinitely. It is also possible that a workload that issues only blocking requests will receive unlimited bandwidth in accessing the network or storage device.

Scheduler 56 may maintain fairness among the workloads in any suitable manner and using any suitable criteria. In one example embodiment, scheduler 56 may allocate bandwidth each workload based on the workload priority. Within this bandwidth, the scheduler may give preference to blocking requests over non-blocking requests. The method then loops back to step 70 above.

The following example clarifies the concept of blocking and non-blocking I/O requests, and also demonstrates that the same type of I/O request (e.g., readout of a 4 KB page) may be blocking or non-blocking depending on the internal design of the workload. In an example embodiment, two workloads continuously read 4 KB pages over network 40, and process the read data. The first workload performs synchronous readout operations, i.e., issues a read request, waits for the response and only then proceeds to issue the next read request. The second workload performs 100 asynchronous readout operations into a buffer, and is able to process the data in the buffer while subsequent readout operations are in progress.

As can be appreciated, the second workload is better designed to cope with read latency. In the first workload, every read request is a blocking request. The second workload will halt only when its buffer becomes empty. Thus, in the second workload the vast majority of read requests are non-blocking.

Moreover, if the two workloads run concurrently (e.g., by different CPU cores) on a “first-come-first-served” basis, the first workload will also halt while the NIC serves the read requests of the second workload. Thus, when using “first-come-first-served” scheduling of read requests, the overall CPU utilization will be very low.

When using the disclosed technique, on the other hand, scheduler 56 will typically identify the read requests of the first workload as blocking, and (at least most of) the read requests of the second workload as non-blocking. Scheduler 56 will order the read requests such that read requests of the first workload are served before read requests of the second workload. As a result, the idle time of the CPU core running the first workload (and thus the idle time of CPU 24 as a whole) will decrease considerably.

Scheduler 56 may use various techniques, criteria or heuristics for deciding which I/O requests are likely to be blocking and which are likely to be non-blocking. For example, some I/O requests are issued by internal management workloads. In such cases, scheduler 56 is aware of the roles of these I/O requests and can decide which of them are blocking and which are non-blocking. For example, a read request that pages-in a memory page to RAM 28 from a remote location over network 40 (or from disk 32) is likely to be blocking. Thus, scheduler 56 may give preference to read requests that page-in memory pages, relative to other I/O requests.

As another example, when migrating a VM or other process from one compute node to another, I/O requests for memory pages that are accessed frequently by the VM (“hot pages”) may be considered blocking and should be served first. I/O requests for memory pages that are rarely accessed by the VM (“cold pages”) may be considered non-blocking and given low priority. Another class of I/O requests, for pages that are accessed more frequently than the cold pages but less frequently than the hot pages, can also be defined and given some intermediate priority is the order of serving.

In some embodiments, scheduler 56 may receive hints that mark certain I/O requests as blocking or non-blocking, and set the order of serving the I/O requests based on the hints. Such hints may be generated, for example, by the workloads themselves, e.g., by the guest operating-systems (OS) of VMs 52, by hypervisor 48, or by any other entity. For example, the guest OS of a VM may indicate to scheduler 56 that a certain I/O request is synchronous (and therefore likely to be blocking), and/or that a certain I/O request is asynchronous (and therefore likely to be non-blocking).

As another example, a guest OS may indicate to scheduler 56 that a certain write request is a barrier-write request, which blocks subsequent write requests until served. A barrier-write request is likely to be regarded as blocking. Additionally or alternatively, the guest OS may indicate to scheduler 56 that a certain write request is a normal (not barrier) write request, and therefore likely to be non-blocking.

In other embodiments, scheduler 56 may receive a notification that a certain workload is idle, or at least partially idle (e.g., under-utilizing its allocated resources). If this workload also has issued an I/O request that is currently pending, scheduler 56 may assume that the pending I/O request is blocking, and give it precedence over other I/O requests. In other words, scheduler 56 may give precedence to I/O requests that are issued by workloads that are identified as currently idle.

In an embodiment, hypervisor 48 may ascertain that a workload is idle due to a pending I/O request, for example, by detecting a drop in CPU-resource requirements by the workload after the I/O request has been issued, and/or an increase in CPU-resource requirements by the workload after the I/O request has completed.

In yet other embodiments, scheduler 56 may distinguish between blocking and non-blocking I/O requests without explicit side information, but rather based on heuristics that are statistically valid. For example, the scheduler may give preference to read requests relative to write requests, assuming that write requests are typically not barrier-writes, but read requests have a non-negligible probability of being synchronous.

In accordance with another heuristic, scheduler 56 may give preference to I/O requests that transfer (read or write) smaller data sizes, relative to I/O requests that transfer larger data sizes. Such a criterion is useful because large I/O transactions cause blocking for longer periods of time than small I/O transactions. Moreover, larger I/O transactions have a higher likelihood of belonging to background processes that are less sensitive to delay.

In yet other embodiments, scheduler 56 may set the order of serving I/O requests based on the types of workloads that issued them. In an example embodiment, the scheduler gives precedence to I/O requests issued by an Apache HTTP server workload, relative to I/O requests issued by a backup application workload or a video streaming workload. In a backup application, it can be assumed that statistically most I/O requests are non-blocking. A video streaming application typically employs some internal buffering, and therefore can tolerate some latency assuming reasonable fairness is maintained. Scheduler 56 may identify or estimate the type of a given workload, for example, based on the pattern of I/O requests issued by the workload.

The ordering criteria listed above are depicted purely by way of example. In alternative embodiments, scheduler 56 may order the I/O requests in accordance with any other suitable criterion that aims to minimize the idle time of the processor or processors running the workloads.

For example, in many of the above examples, scheduler 56 gives precedence to blocking I/O requests, which cause a workload to halt. In alternative embodiments, scheduler 56 may also identify and give precedence to I/O requests that cause a workload to under-utilize the resources it has been allocated. In other words, an I/O request may be identified as “partially-blocking,” i.e., as preventing a workload from fully utilizing its allocated resources. Scheduler 56 may serve such partially-blocking I/O requests before serving non-blocking I/O requests.

Although the embodiments described herein mainly address scheduling of access requests to a network or a storage device, the methods and systems described herein can also be used in other applications in which workloads compete for a resource, such as in accessing local RAM or remote RAM (RAM located on a different compute node).

### Ordering of I/O Requests by Remote Elements

In some embodiments, the identification of blocking and non-blocking I/O requests is performed by scheduler 56, but the actual ordering of the I/O requests is applied by one or more elements that are external to computer 20. Such remote elements may belong to network 40, or may be located across network 40.

Consider, for example, I/O requests that are sent from computer 20 over network 40 to one or more remote compute nodes and/or storage devices. Such I/O requests typically traverse remote elements such as network switches, remote NICs in remote compute nodes, and/or remote storage devices.

In some embodiments, scheduler 56 sends one or more hints to one or more such remote elements. The remote elements may then serve the I/O requests in accordance with the desired order based on the hints. Each remote element may comprise a scheduler that receives the hints and schedule the I/O requests accordingly.

The hints may, for example, distinguish between blocking and non-blocking I/O requests, or otherwise indicate the desired ordering to the remote elements. A given hint may originate from the OS or hypervisor of computer 20, as described above, and forwarded to the remote elements. Additionally or alternatively, a given hint may be generated by scheduler 56.

The specific hinting mechanism may vary from one type of remote element to another. In an example embodiment, scheduler 56 provides a hint to a network switch or to a NIC at a destination compute node by setting appropriate Quality-of-Service (QoS) fields of the underlying network protocol being used. In Ethernet, for example, scheduler 56 may set the Class-of Service (CoS) field for this purpose. If the protocol in question does not support a suitable field, scheduler 56 may provide, for example, software hints rather than hardware hints.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method, comprising:
receiving, from one or more workloads that are processed by one or more processors, requests to access data over a communication network or on a storage device;
defining an order among the requests, in accordance with a criterion that aims to minimize an overall idle time of the one or more processors in processing the multiple workloads; and
serving the requests in accordance with the defined order.

2. The method according to claim 1, wherein defining the order comprises distinguishing between blocking requests and non-blocking requests, and giving precedence to one or more of the blocking requests over one or more of the non-blocking requests.

3. The method according to claim 1, wherein defining the order comprises giving precedence to a request that is issued by a first workload and blocks processing of a second workload.

4. The method according to claim 1, wherein defining the order comprises receiving a hint from an operating system or from a virtualization layer, and setting the order based on the hint.

5. The method according to claim 4, wherein the workloads, and the operating system or virtualization layer, run in a given compute node, and wherein setting the order comprises providing the hint to a remote element external to the given compute node.

6. The method according to claim 1, wherein defining the order comprises receiving, from an operating system or from a virtualization layer, a notification that a given workload is idle, and setting the order based on the notification.

7. The method according to claim 1, wherein defining the order comprises giving precedence to a first I/O request that pages-in a memory page into a local memory from the communication network or from the storage device, relative to a second I/O request that does not page-in any memory page.

8. The method according to claim 1, wherein defining the order comprises giving precedence to a first I/O request that accesses first data having a first access frequency, relative to a second I/O request that accesses second data having a second access frequency, lower than the first access frequency.

9. The method according to claim 1, wherein defining the order comprises giving precedence to a first I/O request identified as synchronous, relative to a second I/O request identified as asynchronous.

10. The method according to claim 1, wherein defining the order comprises giving precedence to a first write request identified as a barrier write, relative to a second write request identified as a non-barrier write.

11. The method according to claim 1, wherein defining the order comprises giving precedence to a read request relative to a write request.

12. The method according to claim 1, wherein defining the order comprises giving precedence to a first I/O request that transfers first data having a first data size, relative to a second I/O request that transfers second data having a second data size, larger than the first data size.

13. The method according to claim 1, wherein defining the order comprises giving precedence to a first I/O request issued by a first type of workload, relative to a second I/O request issued by a second type of workload.

14. An apparatus, comprising:
an interface for connecting to a communication network or a storage device; and
a processor, which is configured to receive, from one or more workloads that are processed by one or more processors, requests to access data over the communication network or on the storage device, to define an order among the requests in accordance with a criterion that aims to minimize an overall idle time of the one or more processors in processing the multiple workloads, and to serve the requests in accordance with the defined order.

15. The apparatus according to claim 14, wherein the processor is configured to define the order by distinguishing between blocking requests and non-blocking requests, and giving precedence to one or more of the blocking requests over one or more of the non-blocking requests.

16. The apparatus according to claim 14, wherein the processor is configured to give precedence to a request that is issued by a first workload and blocks processing of a second workload.

17. The apparatus according to claim 14, wherein the processor is configured to receive a hint from an operating system or from a virtualization layer, and to set the order based on the hint.

18. The apparatus according to claim 17, wherein the processor is comprised in a given compute node, and is configured to provide the hint to a remote element external to the given compute node.

19. The apparatus according to claim 14, wherein the processor is configured to receive, from an operating system or from a virtualization layer, a notification that a given workload is idle, and to set the order based on the notification.

20. The apparatus according to claim 14, wherein the processor is configured to give precedence to a first I/O request that pages-in a memory page into a local memory from the communication network or from the storage device, relative to a second I/O request that does not page-in any memory page.

21. The apparatus according to claim 14, wherein the processor is configured to give precedence to a first I/O request that accesses first data having a first access frequency, relative to a second I/O request that accesses second data having a second access frequency, lower than the first access frequency.

22. The apparatus according to claim 14, wherein the processor is configured to give precedence to a first I/O request identified as synchronous, relative to a second I/O request identified as asynchronous.

23. The apparatus according to claim 14, wherein the processor is configured to give precedence to a first write request identified as a barrier write, relative to a second write request identified as a non-barrier write.

24. The apparatus according to claim 14, wherein the processor is configured to give precedence to a read request relative to a write request.

25. The apparatus according to claim 14, wherein the processor is configured to give precedence to a first I/O request that transfers first data having a first data size, relative to a second I/O request that transfers second data having a second data size, larger than the first data size.

26. The apparatus according to claim 14, wherein the processor is configured to give precedence to a first I/O request issued by a first type of workload, relative to a second I/O request issued by a second type of workload.

27. A computer software product, the product comprising a tangible non-transitory computer-readable medium in which program instructions are stored, which instructions, when read by a processor, cause the processor to receive, from one or more workloads that are processed by one or more processors, requests to access data over a communication network or on a storage device, to define an order among the requests in accordance with a criterion that aims to minimize an overall idle time of the one or more processors in processing the multiple workloads, and to serve the requests in accordance with the defined order.
